(19) United States
(12) Patent Application Publication
(10) Pub. No.: US 2022/0306104 A1
(43) Pub. Date: Sep. 29, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Atsuhiro Sekikawa, Wako-shi (JP); Shotaro Taniguchi, Wako-shi (JP)

(21) Appl. No.: 17/681,862

(22) Filed: Feb. 28, 2022

(30) Foreign Application Priority Data
Mar. 25, 2021 (JP) 2021-052087

(51) Int. Cl. B60W 30/16; B60W 40/09; B60W 30/14; B60W 60/00; B60W 50/14; B60W 10/20; G06V 20/59; G06V 40/16

(52) U.S. Cl. CPC B60W 30/16; B60W 40/09; B60W 30/143; B60W 60/0015; B60W 50/14; B60W 10/20; G06V 20/597; G06V 40/172; B60W 2050/146; B60W 2420/42; B60W 2540/043; B60W 2540/215; B60W 2540/225; B60W 2540/30; B60W 2556/10; B60W 2556/45

(57) ABSTRACT

A vehicle control device according to an embodiment includes: an estimator configured to estimate a personal space in which a position of a vehicle is a reference based on a feature of an occupant of the vehicle; a recognizer configured to recognize a surrounding situation of the vehicle including the personal space estimated by the estimator; and a driving controller configured to control one or both of steering and an acceleration or deceleration speed of the vehicle based on a situation in the personal space recognized by the recognizer.

### CROSS-REFERENCE TO RELATED APPLICATION

Priority is claimed on Japanese Patent Application No. 2021-052087, filed Mar. 25, 2021, the content of which is incorporated herein by reference.

### BACKGROUND

### Field of the Invention

The present invention relates to a vehicle control device, a vehicle control method, and a storage medium.

### Description of Related Art

In recent years, studies of automated vehicle control have been conducted. With this, a technology for generating a motion target of an own vehicle in accordance with preset safety conditions and performing automated driving in accordance with the generated motion target so that drivers of an adjacent vehicle and the own vehicle do not feel risks at predicted positions of the adjacent vehicle and the own vehicle when the adjacent vehicle completes lane changing has been disclosed (for example, Japanese Unexamined Patent Application, First Publication No. 2018-144695).

### SUMMARY

However, a sensation at a timing at which driving control based on a surrounding situation or the like is performed differ for each occupant. Accordingly, as in the technology of the related art, driving control in which a plurality of drivers do not feel risks cannot be performed simply under preset fixed safety conditions.

The present invention is devised in view of such circumstances and an objective of the present invention is to provide a vehicle control device, a vehicle control method, and a storage medium capable of performing driving control at a more appropriate timing depending on an occupant.

A vehicle control device, a vehicle control method, and a storage medium according to the present invention adopt the following configurations.

(1) According to an aspect of the present invention, a vehicle control device includes: an estimator configured to estimate a personal space in which a position of a vehicle is a reference based on a feature of an occupant of the vehicle; a recognizer configured to recognize a surrounding situation of the vehicle including the personal space estimated by the estimator; and a driving controller configured to control one or both of steering and an acceleration or deceleration speed of the vehicle based on a situation in the personal space recognized by the recognizer.

(2) The vehicle control device according to the aspect (1) may further include an output controller configured to cause an outputter to output information for inputting information regarding the feature of the occupant. The estimator may estimate the personal space of the occupant based on information input by the occupant in response to the information output to the outputter.

(3) In the vehicle control device according to the aspect (1), the estimator may update the personal space based on a manual driving history of the vehicle by the occupant.

(4) In the vehicle control device according to the aspect (2), after the driving controller performs driving control based on a situation in the personal space, the output controller may cause the outputter to output inquiry information about the driving control and the estimator may update the personal space based on response information to the inquiry information output by the outputter.

(5) The vehicle control device according to the aspect (1) may further include an occupant state detector configured to detect a state of the occupant. The estimator may update the personal space based on a visual line direction of the occupant detected by the occupant state detector.

(6) In the vehicle control device according to the aspect (2), the output controller may output information including at least the feature of the occupant and information regarding the personal space estimated based on the feature to an external device.

(7) In the vehicle control device according to the aspect (1), the estimator may transmit information regarding a feature of the occupant to an external device and acquires a personal space which is based on the feature of the occupant from the external device.

(8) According to another aspect of the present invention, a vehicle control method causes a computer of a vehicle control device to perform: estimating a personal space in which a position of a vehicle is a reference based on a feature of an occupant of the vehicle; recognizing a surrounding situation of the vehicle including the estimated personal space; and controlling one or both of steering and an acceleration or deceleration speed of the vehicle based on a situation in the recognized personal space.

(9) According to still another aspect of the present invention, a computer-readable non-transitory storage medium stores a program causing a computer of a vehicle control device to perform: estimating a personal space in which a position of a vehicle is a reference based on a feature of an occupant of the vehicle; recognizing a surrounding situation of the vehicle including the estimated personal space; and controlling one or both of steering and an acceleration or deceleration speed of the vehicle based on a situation in the recognized personal space.

According to the aspects of (1) to (9), it is possible to perform driving control at a more appropriate timing in accordance with an occupant.

### BRIEF DESCRIPTION OF THE DRAWINGS

FIG. 1 is a diagram illustrating a configuration of a vehicle system including a vehicle control device according to a first embodiment.

FIG. 2 is a diagram illustrating functional configurations of first and second controllers.

FIG. 3 is a diagram illustrating a personal space.

FIG. 4 is a diagram illustrating a process of a driving controller.

FIG. 5 is a diagram illustrating an example of an image for inputting feature information of an occupant.

FIG. 6 is a diagram illustrating an example of content of personal space information.

FIG. 7 is a diagram illustrating an example of an image for prompting an occupant to set a personal space.

FIG. 8 is a diagram illustrating a change in the personal space in real time.

FIG. 9 is a diagram illustrating an example of an image indicating questionnaire information.

FIG. 10 is a diagram illustrating adjustment of the personal space.

FIG. 11 is a diagram illustrating a process related to driving control in which the personal space is used.

FIG. 12 is a flowchart illustrating an example of a flow of a process of updating the personal space.

FIG. 13 is a diagram illustrating an example of a system configuration of a management system including a vehicle control device according to a second embodiment.

FIG. 14 is a sequence diagram illustrating an example of a flow of a process performed by the management system according to the second embodiment.

### DESCRIPTION OF EMBODIMENTS

Hereinafter, embodiments of a vehicle control device, a vehicle control method, and a storage medium according to the present invention will be described with reference to the drawings. Hereinafter, for example, embodiments in which a vehicle control device is applied to an automated driving vehicle will be described. The automated driving is, for example, controlling one or both of steering or a speed of a vehicle automatically and performing of driving control. The driving control may include, for example, various kinds of driving control such as a lane keeping assistance system (LKAS), auto lane changing (ALC), an adaptive cruise control system (ACC), a collision mitigation brake system (CMBS). The driving control may include a driving support control such as advanced driver assistance system (ADAS). Driving of an automated driving vehicle may be controlled through manual driving of an occupant (a driver).

### First Embodiment

### Overall Configuration

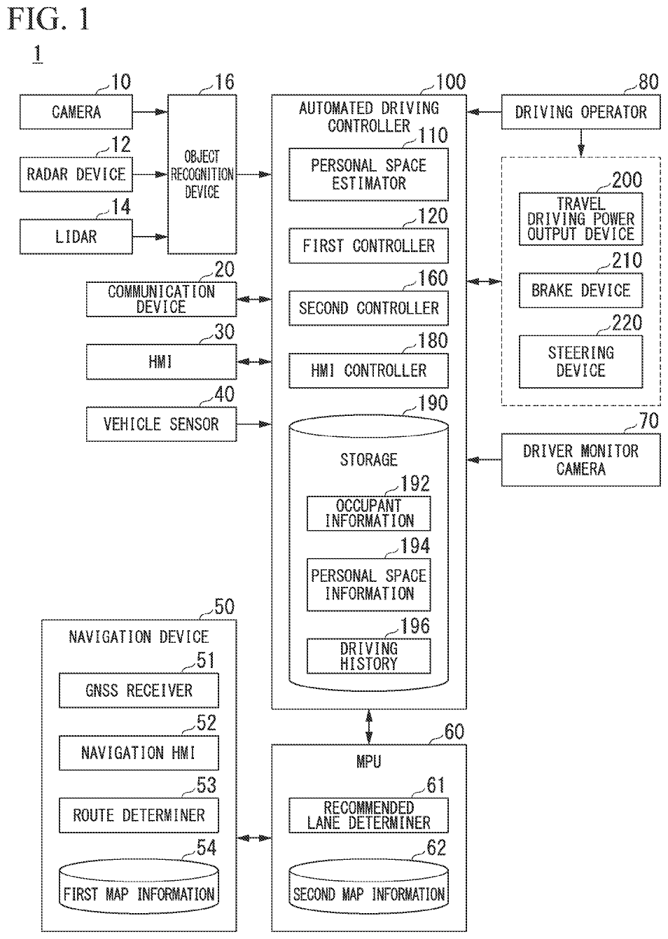

FIG. 1 is a diagram illustrating a configuration of a vehicle system 1 including a vehicle control device according to a first embodiment. A vehicle in which the vehicle system 1 is mounted (hereinafter referred to as a vehicle M) is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. The electric motor operates using power generated by a power generator connected to the internal combustion engine or power discharged from a battery (a storage cell) such as a secondary cell or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, an automated driving controller 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added. The automated driving controller 100 is an example of a “vehicle control device.” A combination of the camera 10, the radar device 12, the LIDAR 14, the object recognition device 16 is an example of an “external sensor.” The HMI 30 is an example of an “outputter.” The driver monitor camera 70 is an example of an “occupant state detector.”

The camera 10 is, for example, a digital camera that uses a solid-state image sensor such as a charged coupled device (CCD) or a complementary metal oxide semiconductor (CMOS). The camera 10 is mounted on any portion of the vehicle M in which the vehicle system 1 is mounted. When the camera 10 images a front side, the camera 10 is mounted on an upper portion of a front windshield, a rear surface of a rearview mirror, a frontal portion of the vehicle body, or the like. When the camera 10 images a rear side, the camera 10 is mounted on an upper portion of a rear windshield, a backdoor, or the like. For example, the camera 10 images a lateral side, the camera 10 is mounted on a rearview mirror or the like. For example, the camera 10 repeatedly images the surroundings of the vehicle M periodically. The camera 10 may be a stereo camera.

The radar device 12 radiates radio waves such as millimeter waves to the surroundings of the vehicle M and detects radio waves (reflected waves) reflected from a surrounding object to detect at least a position (a distance from and an azimuth of) of the object. The radar device 12 is mounted on any portion of the vehicle M. The radar device 12 may detect a position and a speed of an object in conformity with a frequency modulated continuous wave (FM-CW) scheme.

The LIDAR 14 radiates light to the surroundings of the vehicle M and measures scattered light. The LIDAR 14 detects a distance to a target based on a time taken from light emission to light reception. The radiated light is, for example, pulsed laser light. The LIDAR 14 is mounted on any portions of the vehicle M.

The object recognition device 16 performs sensor fusion processing on detection results obtained by some or all of the camera 10, the radar device 12, and the LIDAR 14 and recognizes positions, kinds, speeds, and the like of surrounding objects of the vehicle M. The objects include, for example, other vehicles (for example, surrounding vehicles within a predetermined distance), pedestrians, bicycles, and, structures on roads. The structures on roads include, for example, road signs, traffic control signals, crossings, curbstones, median strips, guardrails, and fences. The structures on roads may include, for example, road surface markers such as road demarcation lines, crosswalks, bicycle crossing zones, and temporary stop lines drawn or attached on roads. The object recognition device 16 outputs recognition results to the automated driving controller 100. The object recognition device 16 may output detection results of the camera 10, the radar device 12, and the LIDAR 14 to the automated driving controller 100, as they are. In this case, the object recognition device 16 may be omitted from the configuration of the vehicle system 1 or the external sensor. The object recognition device 16 may be included in the automated driving controller 100.

The communication device 20 communicates with, for example, another vehicle around the vehicle M, a terminal device of a user using the vehicle M, or various server devices by using, for example, a network such as a cellular network, a Wi-Fi network, Bluetooth (registered trademark), dedicated short range communication (DSRC), a local area network (LAN), a wide area network (WAN), or the Internet.

The HMI 30 outputs various kinds of information to occupants of the vehicle M and receives input operations by the occupants. The HMI 30 includes, for example, various display devices, speakers, buzzers, touch panels, switches, keys, and microphones. The various display devices are, for example, a liquid crystal display (LCD) and an organic electro-luminescence (EL) display device. For example, a display device is installed in a portion of an instrument panel in front of a driver seat (a seat closest to a steering wheel) and is provided at a position viewed through a gap of the steering wheel or over the steering wheel by an occupant. The display device may be installed in the middle of the instrument panel. The display device may be a head-up display (HUD). The HUD causes the eyes of an occupant sitting on the driver seat to view a virtual image by projecting an image to a part of the front windshield in front of the driver seat. The display device displays an image generated by the HMI controller to be described below. The HMI 30 may include driving changeover switches that switches between the automated driving and the manual driving by an occupant.

The vehicle sensor 40 includes a vehicle speed sensor that detects a speed of the vehicle M, an acceleration sensor that detects acceleration, a yaw rate sensor that detects a yaw rate (for example, a rotational angular velocity around a vertical axis passing through a center of gravity point of the vehicle M), and an azimuth sensor that detects a direction of the vehicle M. In the vehicle sensor 40, a positional sensor that detects a position of the vehicle M may be provided. The positional sensor is, for example, a sensor that acquires positional information (latitude and longitude information) from a Global Positioning System (GPS) device. The positional sensor may be a sensor that acquires positional information using a global navigation satellite system (GNSS) receiver 51 of the navigation device 50. In the vehicle sensor 40, a fuel sensor that measures a residual amount of a fuel of the vehicle M may be provided. A result detected by the vehicle sensor 40 is output to the automated driving controller 100.

The navigation device 50 includes, for example, the GNSS receiver 51, a navigation HMI 52, and a route determiner 53. The navigation device 50 retains first map information 54 in a storage device such as a hard disk drive (HDD) or a flash memory. The GNSS receiver 51 identifies a position of the vehicle M based on signals received from GNSS satellites. The position of the vehicle M may be identified or complemented for by an inertial navigation system (INS) using an output of the vehicle sensor 40. The navigation HMI 52 includes a display device, a speaker, a touch panel, and a key. The GNSS receiver 51 may be provided in the vehicle sensor 40. The navigation HMI 52 may be partially or entirely common to the above-described HMI 30. The route determiner 53 determines, for example, a route from a position of the vehicle M identified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads of a predetermined section and nodes connected by the links. The first map information 54 may include point of interest (POI) information. The route on the map is output to the MPU 60. The navigation device 50 may perform route guidance using the navigation HMI 52 based on the route on the map. The navigation device 50 may transmit a present position and a destination to a navigation server through the communication device 20 and acquire the same route equal to the route on the map from the navigation server. The navigation device 50 outputs the determined route on the map to the MPU 60.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for every 100 ml) and determines a recommended lane for each block with reference to the second map information 62. For example, the recommended lane determiner 61 determines in which lane the vehicle travels from the left. When there is a branching location in the route on the map, the recommended lane determiner 61 determines a recommended lane so that the vehicle M can travel in a reasonable route to move to a branching destination.

The second map information 62 is map information that is more accurate than the first map information 54. The second map information 62 includes, for example, information regarding road shapes or road structures. The road shapes include, for example, the number of lanes, radii of curvature (or curvature) of roads, widths, and gradients, as more detailed road shapes than the first map information 54. The foregoing information may be stored in the first map information 54. The information regarding road structures may include information such as kinds and positions of road structures, and directions, sizes, shapes, colors, and the like of road structures in extension directions of roads. For the kinds of road structures, a road demarcation line may be one kind of road structure or each of a lane mark, a curbstone, a median strip, and the like belonging to the road demarcation line may be another kind of road structure. The kinds of road demarcation lines may include, for example, a road demarcation line indicating that a lane can be changed and a road demarcation line indicating a lane cannot be changed. For example, the kinds of road demarcation line may be set for each road or each section of a lane in which a link is a reference, or a plurality of kinds of road demarcation lines may be set in one link.

The second map information 62 may include positional information (longitude and latitude) of roads or buildings, address information (address and postal number), and facility information. The second map information 62 may be updated frequently by causing the communication device 20 to communicate with an external device. The first map information 54 and the second map information 62 may be provided together as map information. The map information (the first map information 54 and the second map information 62) may be stored in a storage 190.

The driver monitor camera 70 is, for example, a digital camera that uses a solid-state image sensor such as a CCD or a CMOS. The driver monitor camera 70 is mounted on any portion in the vehicle M at a position and in a direction in which the head of a driver sitting on the driver seat or an occupant sitting on a front seat or a back seat of the vehicle M can be imaged from the front surface (in a direction in which the face is imaged). For example, the driver monitor camera 70 is mounted in an upper portion of the display device provided in the middle portion of the instrument panel of the vehicle M, an upper portion of a front windshield, or a rearview mirror, or the like. For example, the driver monitor camera 70 repeatedly captures an image including a vehicle interior periodically.

The driving operator 80 includes, for example, a steering wheel, an accelerator pedal, a brake pedal. The driving operator 80 may include a shift lever, a heteromorphic steering wheel, a joystick, and other operators. For example, an operation detector that detects whether there is an operation or an operation amount of an operator by an occupant is mounted in each operator of the driving operator 80. The operation detector detects, for example, a steering angle or a steering torque of the steering wheel or a stepping amount or the like of the accelerator pedal or the brake pedal. The operation detector outputs a detection result to the automated driving controller 100, the travel driving power output device 200, or one or both of the brake device 210 and the steering device 220.

The automated driving controller 100 includes, for example, a personal space estimator 110, a first controller 120, a second controller 160, an HMI controller 180, and a storage 190. Each of the personal space estimator 110, the first controller 120, the second controller 160, and the HMI controller 180 is implemented, for example, by causing a hardware processor such as a central processing unit (CPU) to execute a program (software). Some or all of the constituent elements may be implemented by hardware (a circuit unit including circuitry) such as a large scale integration (LSI), an application specific integrated circuit (ASIC), a field-programmable gate array (FPGA), or a graphics processing unit (GPU) or may be implemented by software and hardware in cooperation. The above-described program may be stored in advance in a storage device (a storage device including a non-transitory storage medium) such as an HDD or a flash memory of the automated driving controller 100 or may be stored in a detachably mounted storage medium such as a DVD or a CD-ROM so that the storage medium (a non-transitory storage medium) is mounted on a drive device, a card slot, or the like to be installed on the storage device of the automated driving controller 100. The personal space estimator 110 is an example of an “estimator.” A combination of the action plan generator 140 and the second controller 160 is an example of a “driving controller.” The HMI controller 180 is an example of an “output controller.” For example, the automated driving controller 100 may switch between the automated driving and the manual driving by receiving an operation on the driving changeover switch or may switch between the automated driving and the manual driving in accordance with a surrounding situation of the vehicle M. The automated driving controller 100 may control switching from the automated driving to the manual driving when an operation (a driving operation) of a predetermined amount or more on the driving operator 80 by an occupant performing the automated driving is received.

The storage 190 may be implemented by any of the foregoing storage devices, an electrically erasable programmable read only memory (EEPROM), a read-only memory (ROM), or a random access memory (RAM). The storage 190 stores, for example, various kinds of information such as occupant information 192, personal space information 194, a driving history 196, and a program.

For example, in the occupant information 192, feature information such as a sex or an age is associated with identification information (for example, occupant ID) for identifying an occupant (a driver) driving the vehicle M. The feature information may include, for example, information such as a driving history, personality, or a tendency (for example, habit or preference of a manipulation) of the operation in the manual driving. The occupant information 192 may include authentication information for authenticating an occupant or feature information of the face of an occupant obtained by analyzing an image captured by the driver monitor camera 70. The occupant information 192 may be registered when an occupant first drives the vehicle M or may be registered at a predetermined timing at which the automated driving is performed, or the like. The details of the personal space information 194 will be described below. The driving history 196 includes, for example, a manual driving history of each occupant. The manual driving history includes, for example, an acceleration operation, a braking operation, and a steering operation of an occupant. The manual driving history may include not only the manual driving in a case in which driving control of the driving controller is not performed but also the manual driving in a case in which driving support control such as ADAS is performed or the manual driving for switching from the automated driving to the manual driving. The driving history 196 may include information regarding positions of or speeds (relative positions or relative speeds from the vehicle M) of surrounding vehicles (other vehicles) when an occupant performs the manual driving. The storage 190 may store map information (the first map information 54 and the second map information 62).

The personal space estimator 110 estimates a personal space in which a position of the vehicle M is a reference based on a feature of an occupant of the vehicle M. The personal space is, for example, a region for determining whether to start performing predetermined driving control (driving support) in the automated driving and is estimated based on the feature of the occupant. For example, when an object is in the estimated personal space, speed control or steering control is performed to adjust a distance between the vehicle M and an object or avoid contact through the automated driving. When no vehicle is not in a personal space on a set adjacent lane, lane changing to an adjacent lane through the automated driving is performed. The personal space estimator 110 may identify an occupant (a driver) who drives the vehicle M by referring to the occupant information 192 based on an occupant ID or authentication information received from the HMI 30 or may identify an occupant who drives the vehicle M by analyzing an image captured by the driver monitor camera 70 and referring to the occupant information 192 with feature information of a face obtained as an analysis result.

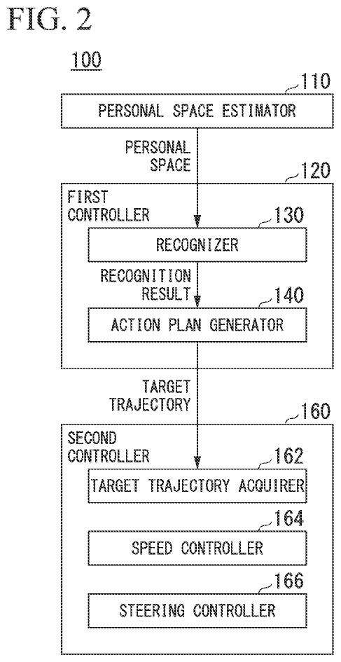

FIG. 2 is a diagram illustrating functional configurations of the first controller 120 and the second controller 160. The first controller 120 includes, for example, a recognizer 130 and an action plan generator 140. The first controller 120 implements, for example, a function by artificial intelligence (AI) and a function by a model given in advance in parallel. For example, a function of “recognizing an intersection” may be implemented by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of the automated driving is guaranteed. The first controller 120 performs control related to the automated driving of the vehicle M based on, for example, an instruction from the MPU 60, the HMI controller 180, or the like.

The recognizer 130 acquires a personal space of the occupant estimated by the personal space estimator 110. The recognizer 130 recognizes a surrounding situation of the vehicle M including the personal space based on recognition results of the external sensor (information input from the camera 10, the radar device 12, and the LIDAR 14 via the object recognition device 16). For example, the recognizer 130 recognizes states such as positions, speeds, or acceleration of the vehicle M and kinds of objects around the vehicle M. A kind of object may be, for example, a kind of object which is a vehicle, a kind of object that is a pedestrian, or each kind which is identified for each vehicle. For example, the positions of the objects are recognized as positions on the absolute coordinates (hereinafter referred to as a vehicle coordinate system) in which a representative point (a center of gravity, a center of a driving shaft, or the like) of the vehicle M is the origin and are used for control. The positions of the objects may be represented as representative points such as centers of gravity, corners, a leading portion of the traveling direction, or the like of the objects or may be represented as expressed regions. The speeds include, for example, speeds (hereinafter referred to as longitudinal speeds) of the vehicle M and other vehicles in a traveling direction (a longitudinal direction) of a lane in which the vehicle M is traveling and speeds (hereinafter referred to as lateral speeds) of the vehicle M and other vehicles in a lateral direction of the lane. A “state” of an object may include, for example, acceleration or jerk of the object or an “action state” (for example, whether a vehicle is changing the lane or is attempting to change the lane), for example, when the object is a moving object such as another object.

The action plan generator 140 generates an action plan for causing the vehicle M to travel based on driving control such as the automated driving based on a recognition result of the recognizer 130. For example, the action plan generator 140 generates a target trajectory along which the vehicle M travels in future automatically (irrespective of an operation or the like by the driver) so that the vehicle M travels along a recommended lane determined by the recommended lane determiner 61 and can also handle a surrounding situation of the vehicle M in principle on the basis of a surrounding road shape or the like which is a based on a recognition result by the recognizer 130 or a present position of the vehicle M acquired from map information. The target trajectory includes, for example, a speed component. For example, the target trajectory is expressed by arranging spots (trajectory points) at which the vehicle M will arrive in sequence. The trajectory point is a spot at which the vehicle M will arrive for each predetermined travel distance (for example, about several [ml]) in a distance on a road. Apart from the trajectory points, a target speed (and target acceleration) is generated as a part of the target trajectory for each of predetermined sampling times (for example, about every fractions of a second). The trajectory point may be a position at which the vehicle M will arrive at the sampling time for each predetermined sampling time. In this case, information regarding the target speed (and the target acceleration) is expressed according to an interval between the trajectory points.

The action plan generator 140 may set an automated driving event when the target trajectory is generated. As the automated driving event, events include, for example, a constant speed traveling event for causing the vehicle M to travel at a constant speed in the same lane, a following traveling event for causing the vehicle M to follow another vehicle which is within a predetermined distance (for example, within 100 [ml]) to the front of the vehicle M and is the closest to the vehicle M (hereinafter referred to as a front vehicle), a lane changing event for changing a lane of the vehicle M from an own lane to an adjacent lane, a branching event for branching the vehicle M from a branching spot of a road to a lane toward a destination, a joining event for joining the vehicle M to a main lane at a joining spot, a takeover event for ending the automated driving and switching to the manual driving, an intersection traveling event for causing the vehicle M to go straight (pass) or turn right or left at an intersection, and a parking event for automatically parking the vehicle M at a predetermined position. The events include, for example, an overtaking event for changing a lane of the vehicle M to an adjacent lane temporarily, taking over a front vehicle, and then changing the lane to the original lane again and an avoiding event for performing at least one braking and steering of the vehicle M to avoid contact with an object which is in front of the vehicle M. Of the above-described events, starting or execution of an event may be controlled with regard to a predetermined event (for example, the avoiding event, the following traveling event, the lane changing event, the intersection traveling event, and the parking event) based on the situation in the above-described personal space. The action plan generator 140 may limit execution of a predetermined event (for example, the lane changing event or the intersection traveling event) based on a residual amount of a fuel of the vehicle M. In this case, the action plan generator 140 does not perform the lane changing event, for example, when the residual amount of the fuel detected by the fuel sensor of the vehicle sensor 40 is less than a predetermined amount. In this way, by limiting the automated driving event when the residual amount of the fuel decreases, it is possible to reduce consumption of the fuel.

For example, the action plan generator 140 may change an event determined in advance in a present section to another event or may set a new event in the present section in accordance with a situation in a personal space recognized when the vehicle M is traveling. The action plan generator 140 may change an event set in advance in the present section to another event or set a new event in the present section in accordance with an operation of an occupant on the HMI 30. The action plan generator 140 generates a target trajectory in accordance with the set event.

The second controller 160 controls the travel driving power output device 200, the brake device 210, and the steering device 220 so that the vehicle M passes along the target trajectory generated by the action plan generator 140 at a scheduled time.

The second controller 160 includes, for example, a target trajectory acquirer 162, a speed controller 164, and a steering controller 166. The target trajectory acquirer 162 acquires information regarding a target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are implemented, for example, by combining feed-forward control and feedback control. For example, the steering controller 166 performs the feed-forward control in accordance with a radius of curvature (or a curvature) of a road in front of the vehicle M and the feedback control based on separation from the target trajectory in combination.

The HMI controller 180 notifies an occupant of predetermined information through the HMI 30. The predetermined information includes, for example information related to traveling of the vehicle M, such as information regarding a state of the vehicle M or information related to driving control. The information regarding the state of the vehicle M includes, for example a speed of the vehicle M, an engine speed, and a shift position. The information regarding the driving control includes, for example, information regarding whether to perform driving control through the automated driving, information for inquiring about whether to start the automated driving, information regarding a situation of driving control through the automated driving (for example, content of an event which is being performed), and information regarding a personal space. The predetermined information may include information unrelated to traveling control of the vehicle M, such as a television program or content (for example, a movie) stored in a storage medium such as a DVD. The predetermined information may include, for example, information regarding a present position or a destination of the vehicle M or a residual amount of a fuel.

For example, the HMI controller 180 may generate an image including the above-described predetermined information and display the generated image on a display device of the HMI 30 or may generate a sound indicating predetermined information and may output the generated sound from a speaker of the HMI 30. The HMI controller 180 may output information received by the HMI 30 to the communication device 20, the navigation device 50, the personal space estimator 110, the first controller 120, or the like. The HMI controller 180 may transmit various kinds of information to be output the HMI 30 to a terminal device used by a user (an occupant) of the vehicle M via the communication device 20. The terminal device is, for example a smartphone or a tablet terminal.

The HMI controller 180 may store, for example, information obtained from the vehicle sensor 40 or information such as operation content (a manual driving operation) of an occupant on the driving operator 80 or a surrounding situation or the like recognized by the recognizer 130 in association with identification information (an occupant ID) of the occupant driving the vehicle M in the driving history 196. The HMI controller 180 may output information including at least a feature of the occupant and information regarding a personal space estimated based on the feature to an external device such as a server through the communication device 20.

The travel driving power output device 200 outputs a travel driving power (torque) for traveling the vehicle M to a driving wheel. The travel driving power output device 200 includes, for example, a combination of an internal combustion engine, an electric motor, and a transmission and an electronic control unit (ECU) controlling them. The ECU controls the foregoing configuration in accordance with information input from the second controller 160 or information input from the accelerator pedal of the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the brake pedal of the driving operator 80 such that a brake torque in accordance with a braking operation is output to each wheel. The brake device 210 may include, as a backup, a mechanism that transmits a hydraulic pressure generated in response to an operation of the brake pedal to the cylinder via a master cylinder. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the steering wheel of the driving operator 80.

### Personal Space Estimator

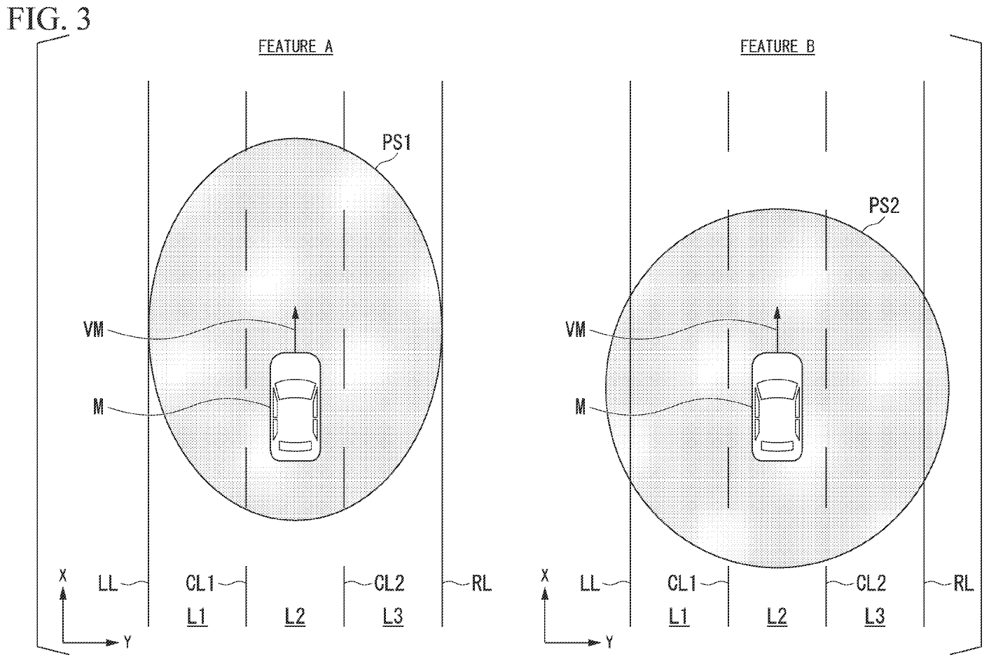

Hereinafter, details of a function of the personal space estimator 110 will be described. FIG. 3 is a diagram illustrating a personal space estimated based on identification. In an example of FIG. 3, the vehicle M traveling at a speed VM on a lane L2 is shown among three lanes L1 to L3 in which the vehicle M can travel in the same direction (the X direction in the drawing). The lane L1 is demarcated by road demarcation lines LL and CL1, the lane L2 is demarcated by road demarcation the line CL1 and a line CL2, and the lane L3 is demarcated by road demarcation the line CL2 and a line RL.

The personal space estimator 110 acquires a feature of an occupant and estimates a personal space based on the acquired feature information. For example, when a feature of an occupant is a “feature A,” a personal space PS1 is shown to the left of FIG. 3. When the feature of the occupant is a “feature B,” a personal space PS2 is shown to the right of FIG. 3. The personal space estimator 110 estimates personal spaces with different shapes or sizes using a position of the vehicle M as a reference based on the feature of the occupant. In the example of FIG. 3, the personal space PS1 for an occupant gazing at in a travel direction (front side) of the vehicle M rather than both lateral sides and the rear side of the vehicle M is set in the case of the feature A. The personal space PS2 for an occupant equally paying attention to the surroundings of the vehicle M is set in the case of the feature B.

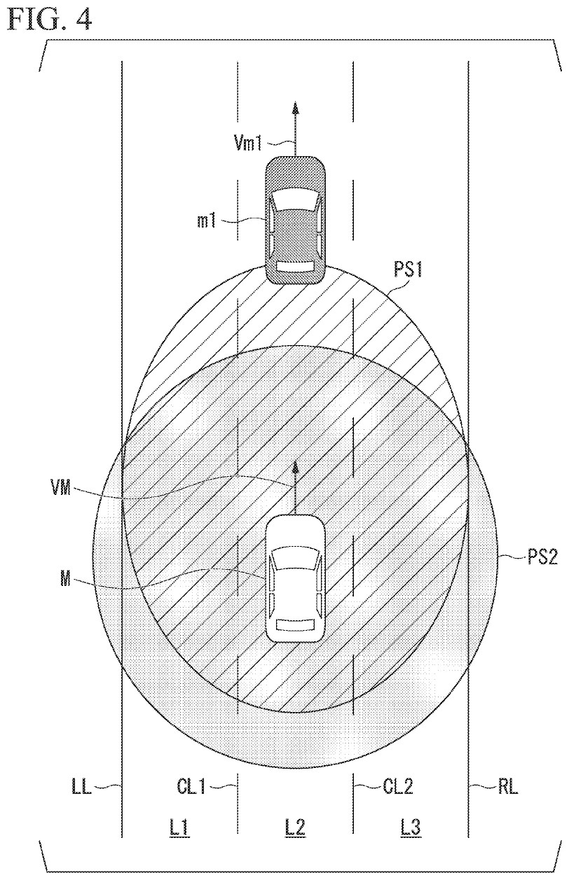

The driving controller performs driving control of the vehicle M, for example, based on a situation in the personal space recognized by the recognizer 130. FIG. 4 is a diagram illustrating a process of the driving controller. In the example of FIG. 4, the personal spaces PS1 and PS2 associated with the features A and B illustrated in FIG. 3 overlap each other when the position of the vehicle M is a reference. In the example of FIG. 4, it is assumed that another vehicle m1 is traveling at a speed Vm1 in front of the vehicle M.

Based on a recognition result of the recognizer 130, the driving controller performs deceleration control or steering control so that the vehicle M does not come into contact with the other vehicle m1 when at least a part of the other vehicle m1 is within the personal space. Here, when the personal space PS1 is set, the driving controller performs deceleration control to prevent contact with the other vehicle m1. When the personal space PS2 is set, driving control (for example, low speed traveling) by the ACC continues without performing the deceleration control. In this way, by performing the driving control using the personal space PS based on the feature of the occupant, it is possible to perform the driving control at a timing closer to a sensation of the occupant.

### Acquiring Feature of Occupant

Next, a method of acquiring a feature of an occupant will be described. For example, the personal space estimator 110 causes the HMI controller 180 to generate information for inputting information regarding the feature of the occupant (hereinafter referred to as feature information), causes the HMI 30 to output the generated information, and acquires the information (the feature information) input by the HMI 30. Hereinafter, information generated by the HMI controller 180 and output by the HMI 30 will be described as an image. However, in addition to (instead of) an image, a sound may be used.

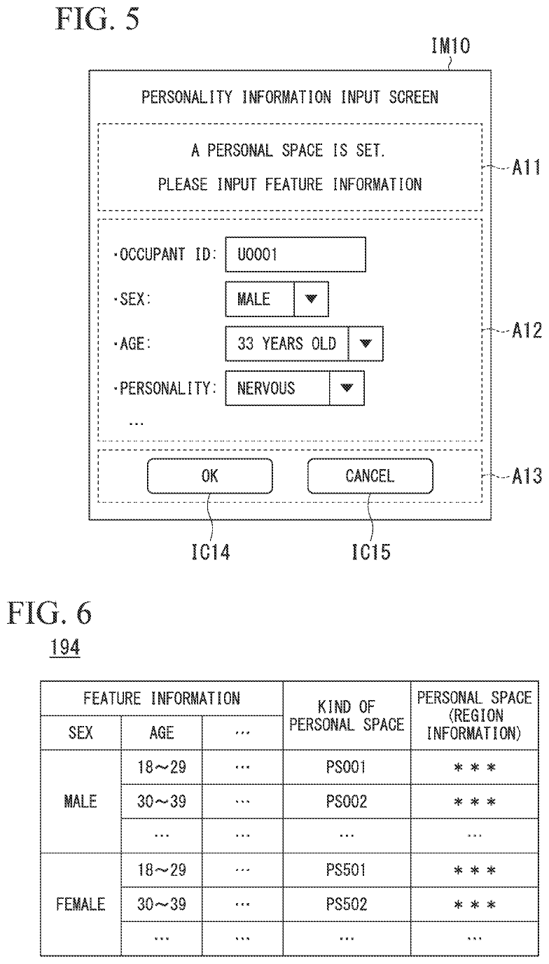

FIG. 5 is a diagram illustrating an example of an image IM1 for inputting feature information of an occupant. A display aspect of a layout, display content, or the like of the image IM10 is not limited to an example of FIG. 5. The same applies to display aspects of other images to be described below. The image IM10 illustrated in FIG. 5 includes, for example, an instruction information display region A11, a feature information input region A12, and a switch display region A13. In the instruction information display region A11, instruction information for prompting an occupant to input feature information is displayed. In the example of FIG. 5, for example, an image indicating text information such as “A personal space is set. Please input feature information.” is displayed in the instruction information display region A11.

For example, a region for inputting an occupant ID and each item such as a sex, an age, and personality which is feature information of the occupant of the vehicle M is displayed in the feature information input region A12. The occupant inputs information in each item displayed in the feature information input region A12 by the HMI 30. When feature information associated with the occupant ID has already been registered in the occupant information 192, only the occupant ID may be input. The feature information input in the feature information input region A12 may include, for example, a driving history of the occupant or a tendency of an operation in the manual driving.

For example, icons IC11 and IC12 are displayed in the switch display region A13. The icons IC11 and IC12 are, for example, graphical user interface (GUI) switches. The same applies to other icons to be described below. When the icon IC11 is selected, the HMI controller 180 receives feature information input in the feature information input region A12 and ends the display of the image IM10. The HMI controller 180 may register the received feature information in the occupant information 192 and may update information stored in the occupant information 192 based on the received feature information. When only the occupant ID is input, the HMI controller 180 may acquire the feature information associated with the matched occupant ID with reference to the occupant information 192 based on the occupant ID. When the icon IC12 is selected, the HMI controller 180 does not receive an input of the feature information and ends the display of the image IM10.

The personal space estimator 110 acquires the personal space associated with the matched feature information with reference to the personal space information 194 based on at least one of the sex, the age, the personality, the tendency of an operation in the manual driving, and the like of the occupant included in the feature information input in the feature information input region A12. FIG. 6 is a diagram illustrating an example of content of the personal space information 194. The personal space information 194 associates, for example, kinds of personal spaces and region information of the personal spaces which are identification information for identifying the personal spaces with the feature information (for example, the sex, the age, and the like). The personal space information 194 is acquired from, for example, an external device communicating with the communication device 20. The personal space estimator 110 can estimate the personal space, for example, based on the feature of the occupant by using the personal space information 194. The personal space estimated by the personal space estimator 110 may be stored in the occupant information 192 in association with the occupant ID.

The personal space estimator 110 may set an average value of a preset personal spaces or the personal space predicted to be safe to start driving control as initial values (a reference personal space) and may adjust the set reference personal space based on the feature of the occupant. For example, when the occupant is male, the personal space estimator 110 estimates a personal space in which a space in front of the vehicle M is broader the reference personal space. When the occupant is female or personality is nervous, the personal space estimator 110 estimates a personal space which is spread equally around the reference personal space.

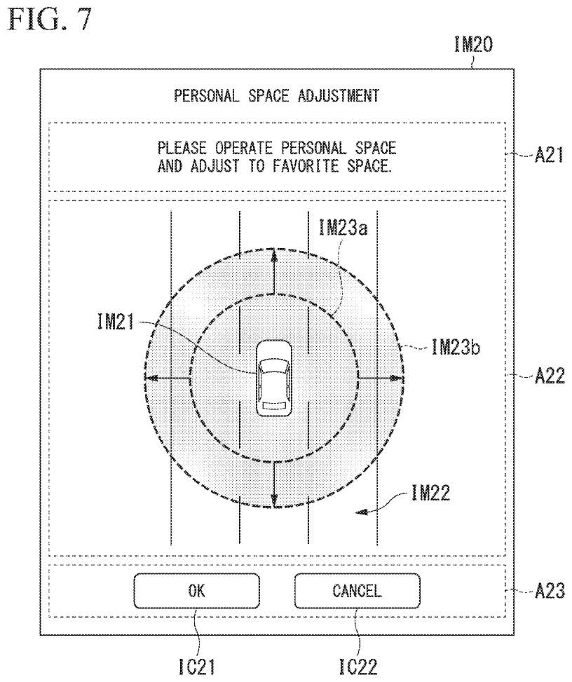

The personal space estimator 110 may cause the HMI controller 180 to generate an image for prompting the occupant to set the personal space, cause the HMI 30 to display the image, and directly adjust the personal space through an operation of the occupant on the displayed image. FIG. 7 is a diagram illustrating an example of an image IM20 for prompting an occupant to directly adjust a personal space. The image IM20 includes, for example, an instruction information display region A21, a personal space adjustment region A22, and a switch display region A23. Instruction information for prompting the occupant to directly adjust the personal space is displayed in the instruction information display region A21. In the example of FIG. 7, an image indicating text information such as “Please adjust the personal space” is displayed in the instruction information display region A21.

For example, a first image IM21 imitating the vehicle M, a second image IM22 imitating a road including a traveling lane of the vehicle M and other lanes (for example, adjacent lanes) in which vehicles can travel in the same direction as the traveling lane, and a third image IM23 imitating a personal space are displayed in the personal space adjustment region A22. A shape of the third image IM23 can be changed through an operation of the occupant. In the example of FIG. 7, a third image IM23a imitating the reference personal space is first displayed and a third image IM23b subsequently adjusted through a sliding operation, a swiping operation, or the like of the occupant is illustrated. The personal space estimator 110 may set a minimum region and a maximum region of the personal space in advance and may control an input of the occupant such that the occupant does not perform the input beyond a range from the minimum region to the maximum region. Thus, a start timing of the driving control is too late or early and the driving control can be performed at an appropriate timing in accordance with a surrounding situation.

For example, icons IC21 and IC22 are displayed in the switch display region A23. When the icon IC21 is selected, the HMI controller 180 receives the personal space information input in the personal space adjustment region A22 and ends the display of the image IM20. When the icon IC22 is selected, the HMI controller 180 does not receive the input of the personal space information and ends the display of the image IM20.

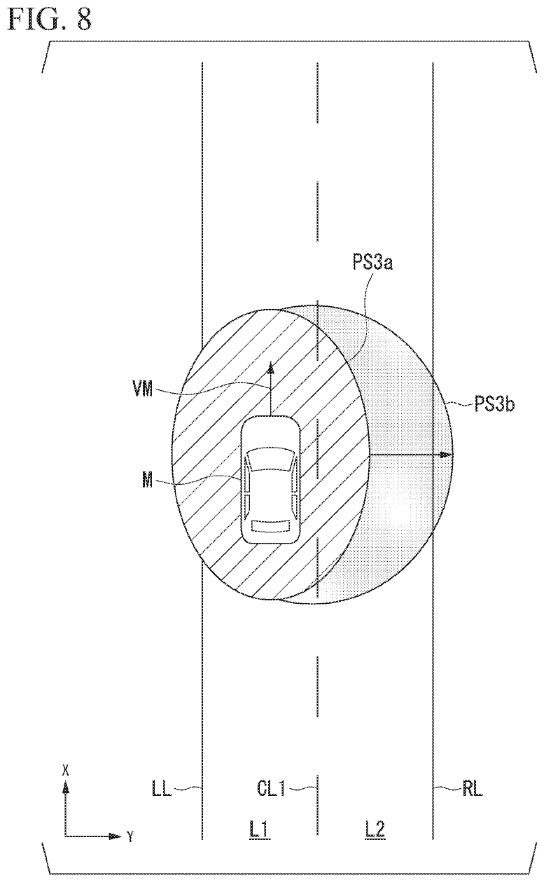

The personal space estimated by the personal space estimator 110 may be fixed irrespective of the content of the driving control performed by the driving controller or a state of the occupant or may be changed in real time in accordance with the content of the driving control or the state of the occupant. FIG. 8 is a diagram illustrating a change in the personal space in real time. In the example of FIG. 8, the vehicle M traveling at the speed VM in the lane L1 between the two lanes L1 and L2 in which the vehicle M can travel in the same direction is illustrated. When the vehicle M continuously travels in the lane L1, the driving controller travels using a personal space PS3a. When the vehicle M performs lane changing from the lane L1 to the lane L2 through the automated driving, the personal space estimator 110 changes the lane to a new personal space PS3b in which an area on the side of the lane L2 of a lane changing destination is spread from the region of the present personal space PS3a and performs lane changing based on a situation in the changed personal space.

The personal space estimator 110 may analyze an image captured by the driver monitor camera 70 and perform a visual line estimation process and may adjust the personal space in accordance with a visual line direction of an occupant (the driver). For example, when the visual line direction of the occupant is the front of the vehicle M or the lane changing destination in the lane changing control through the automated driving, the personal space estimator 110 causes an amount by which the personal space is spread to be smaller than in a case in which the visual line direction of the occupant is not the front of the vehicle M and the lane changing destination. Since the occupant monitors a situation of the front of the vehicle M or the lane changing destination, the lane changing can be performed more safely even in a relatively small personal space. Conversely, when the visual line direction of the occupant is not the front of the vehicle M or the lane changing destination, the amount by which the personal space is spread is increased. Thus, since absence of other vehicles in a broad range is a condition that the lane changing starts, control can be consequently performed such that an execution timing of the lane changing is delayed or the lane changing is not performed. The lane changing can be performed in a safer situation.

For example, when the visual line direction of the occupant is near the front of the vehicle M (less than a predetermined distance from the vehicle M), the personal space estimator 110 causes a region in front of the personal space to be narrower than a present region. For example, when the visual line direction of the occupant is away from the front of the vehicle M (greater than the predetermined distance from the vehicle M), the personal space estimator 110 causes the region in front of the personal space to be broader than the present region. Thus, it is possible to change the size of the personal space in accordance with the visual line direction of the occupant.

The personal space estimator 110 may change the personal space in real time based on a driving state of the occupant. For example, when the driving state is switched to the manual driving through a braking operation (deceleration control) of the occupant during the automated driving, the personal space estimator 110 changes the personal space to a personal space in which a space in the front direction of the vehicle M is broadened more than the present personal space. For example, the driving state is switched to the manual driving through an acceleration operation (acceleration control) of the occupant during the automated driving, the personal space estimator 110 changes the personal space to a personal space in which the space in the front direction of the vehicle M is narrowed more than the present personal space. When the driving state is switched to the manual driving through a steering operation (steering control) of the occupant during the automated driving, the personal space estimator 110 changes the personals space to a personal space in which spaces to the right and left of the vehicle M is narrowed than the present personal space.

As described above, by performing feedback control to change the personal space in accordance with the content of the driving control or the state of the occupant (also including the driving state), it is possible to perform more appropriate driving control in accordance with a situation of the vehicle or the occupant in consideration of a feature of the occupant. Since the driving control is performed at a timing appropriate for a sensation of the occupant, it is possible to reduce a frequency at which the driving state is switched from the automated driving to the manual driving through a driving operation of the occupant.

### Updating Personal Space

The personal space estimator 110 may update the personal space at a predetermined timing. The predetermined timing may be, for example, a predetermined period or a timing at which a traveling time, a traveling distance, or the number of boardings after the setting of the personal space is equal to or greater than a threshold. The predetermined timing may be a timing at which a history information amount stored in the driving history 196 is equal to or greater than a predetermined amount or may be a timing at which an occupant gives an instruction to update the personal space.

For example, the personal space estimator 110 causes the HMI controller 180 to generate questionnaire information for inquiring about an evaluation, an opinion, or a remark of an occupant with regard to the driving control performed by the driving controller based on the present personal space at a predetermined timing and causes the HMI 30 to output the generated questionnaire information. The personal space estimator 110 receives response information (a questionnaire result) of the occupant in response to the questionnaire information and updates the personal space.

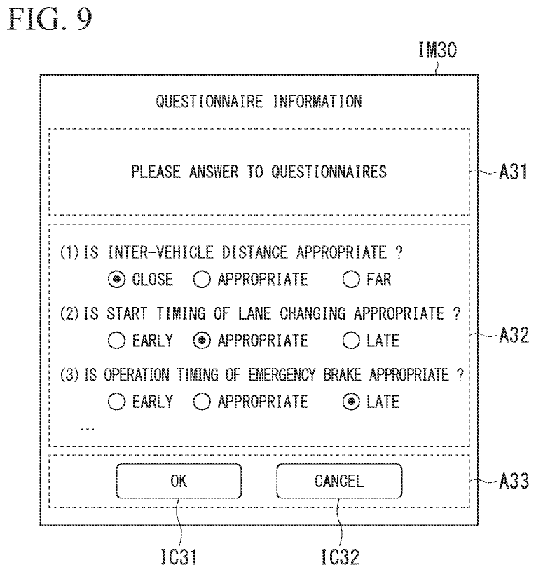

FIG. 9 is a diagram illustrating an example of an image IM30 indicating questionnaire information. The image IM30 includes, for example, an instruction information display region A31, a response input region A32, and a switch display region A33. In the instruction information display region A31, information for urging the occupant to respond to questionnaires indicated by the displayed image IM30 is displayed. In the response input region A32, for example, questionnaire content for the occupant with regard to the driving control performed through the automated driving is displayed. The questionnaire content includes, for example, content related to an execution timing of driving control performed due to presence of another vehicle in the personal space (for example, emergency brake control) or driving control performed due to absence of another vehicle in the personal space (for example, lane changing control). Questionnaire content displayed in the response input region A32 is content related to performed actually driving control. In the example of FIG. 9. For example, an input region (a radio button) for selecting one from a plurality of set choices for each of adjustment of an inter-vehicle distance, a start timing of lane changing, and an operation timing of an emergency brake is displayed in the response input region A32. Specifically, in the example of FIG. 9, response information such as “the inter-vehicle distance is close,” “the starting timing of the lane changing is appropriate,” and “an operation timing of the emergency brake is late.” is input.

For example, icons IC31 and IC32 are displayed in the switch display region A33. When the icon IC31 is selected, the HMI controller 180 receives the response information input in the response input region A32 and ends the display of the image IM30. When the icon IC32 is selected, the HMI controller 180 does not receive the response information and ends the display of the image IM30.

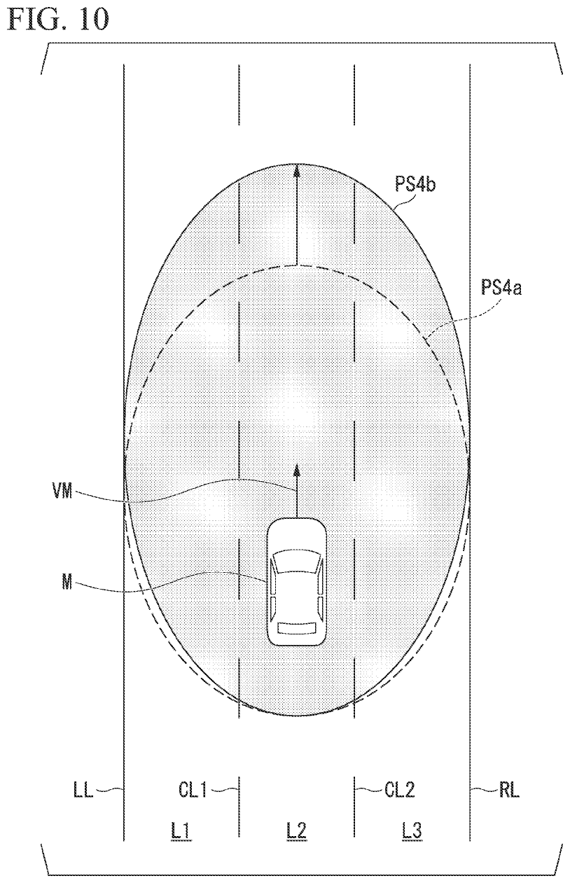

When the HMI controller 180 receives the response information, the personal space estimator 110 updates the present personal space based on the response information. FIG. 10 is a diagram illustrating updating of the personal space. In the example of FIG. 10, the vehicle M is illustrated when it is assumed that the vehicle M is traveling at the speed VM in the lane L2 on a road formed by three lanes L1 to L3 to which the vehicle M can travel in the same direction. Before the updating, a personal space PS4a based on a feature of the occupant (the driver) of the vehicle M is set.

For example, when the personal space based on the response information illustrated in FIG. 9, as described above, is updated, the personal space estimator 110 acquires a feeling of the occupant that an inter-vehicle distance is close and emergency brake is late in the automated driving. Then, the personal space estimator 110 updates the personal space to a personal space PS4b in which a space in the front direction of the vehicle M is spread from the present personal space PS4a so that the inter-vehicle distance is farther and the operation timing of the emergency brake is earlier. For example, the personal space estimator 110 may adjust the region of the personal space based on an expansion amount or a reduction amount allocated to each choice displayed in the response input region A32 or may adjust the expansion amount or the reduction amount in accordance with the combination of the selected content or the feature of the occupant. Thus, it is possible to perform the driving control at a timing close to the sensation of the occupant.

When the personal space is expanded or reduced, the personal space estimator 110 performs control such that a range from the preset minimum region to the preset maximum region of the personal space is not exceeded. Thus, since the execution timing of the driving control is not too late or too early, more appropriate driving control can be performed in accordance with a surrounding situation.

The personal space estimator 110 may update the personal space based on a manual driving history of the occupant included in the driving history 196. In this case, for example, the personal space estimator 110 may acquire information regarding a deceleration timing in the case of approach of a front vehicle to the vehicle M or a timing of steering and an acceleration or deceleration speed during lane changing, and may change a size or shape of the personal space so that a difference decreases when the difference between the acquired information and a timing of steering or an acceleration or deceleration speed based on the present personal space is equal to or greater than a predetermined value. The personal space estimator 110 may update the personal space based on a switching situation from the automated driving to the manual driving through a driving operation included in the driving history 196. The personal space estimator 110 may learn a tendency (for example, habit) of the occupant in the manual driving based on the driving history 196 and update the personal space based on a learning result.

The personal space estimator 110 adjusts the personal space based on one or both of the above-described response information of the questionnaires and driving history. Thus, the driving control can be performed at a matched timing in accordance with the sensation of the occupant.

For example, the personal space is estimated or updated (adjusted) or the automated driving is being performed, the personal space estimator 110 may cause the HMI 30 to display an image indicating information regarding the personal space. Thus, the occupant can be caused to ascertain the estimated and updated personal space and ascertain the start (execution) timing of the driving control more accurately.

### Processing Flow

Next, a flow of a process performed by the automated driving controller 100 according to the first embodiment will be described. Hereinafter, of processes performed by the automated driving controller 100, a process related to the driving control using the personal space and a process of updating the personal space will be mainly described.

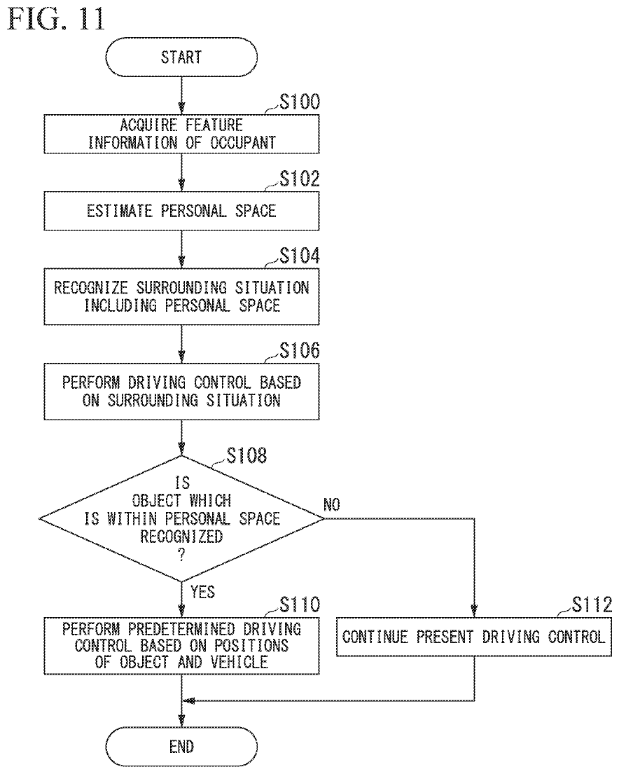

FIG. 11 is a diagram illustrating an example of a process related to driving control in which the personal space is used. The process illustrated in FIG. 11 may be performed at a predetermined timing such as driving start of the vehicle M or execution start of the automated driving, for example.

In the example of FIG. 11, the personal space estimator 110 first acquires feature information of an occupant (step S100) and estimates a personal space in which a position of the vehicle M is a reference based on the acquired feature information (step S102). Subsequently, the recognizer 130 recognizes a surrounding situation of the vehicle M including the personal space (step S104) and performs driving control based on the recognized surrounding situation (step S106).

Subsequently, it is determined whether an object which is within the personal space is recognized (step S108). When it is determined that the object is recognized, the driving controller performs predetermined driving control based on positions of the object and the vehicle (step S110). The predetermined driving control may be, for example, deceleration control for maintaining an inter-vehicle distance to the front vehicle in the ACC to a predetermined distance or may be emergency braking control or steering control for avoiding contact with the object.

When it is determined in the process of step S108 that the object which is within the personal space is not recognized, the driving controller continues the present driving control (step S112). Then, the process of the flowchart ends.

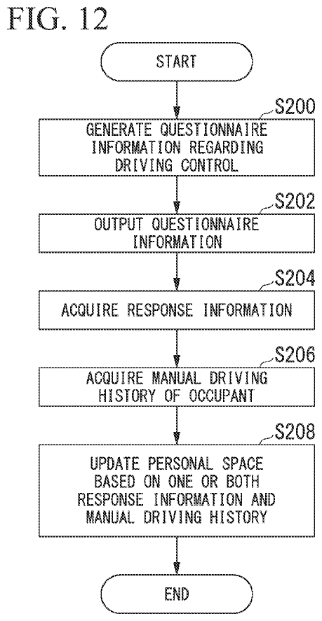

FIG. 12 is a flowchart illustrating an example of a flow of a process of updating the personal space. The process of FIG. 12 may be performed, for example, at a timing at which a traveling time, a traveling distance, or the number of boardings after the setting or updating of the personal space is equal to or greater than a threshold for each predetermined period. In the example of FIG. 12, the personal space estimator 110 causes the HMI controller 180 to generate questionnaire information regarding driving control of the automated driving (step S200) and cause the HMI 30 to output the generated questionnaire information (step S202).

Next, the personal space estimator 110 acquires response information (a questionnaire result) received through an operation of the occupant on the HMI 30 (step S204). Subsequently, the personal space estimator 110 acquires a driving history of the manual driving of the occupant from the driving history 196 stored in the storage 190 (step S206). Subsequently, the personal space estimator 110 updates the personal space based on one or both of the response information and the manual driving history (step S208). Then, the process of the flowchart ends.

According to the above-described first embodiment, by estimating the personal space based on the feature of the occupant and controlling the start timing of the driving control using the estimated personal space, it is possible to perform the driving control at a more appropriate timing. For example, according to the first embodiment, it is possible to recognize the feature (for example, a sex, habit, or the like) of the occupant from the driving history of the occupant and update the personal space to a more appropriate space based on the feature. Accordingly, according to the first embodiment, it is possible to reflect the sensation of the driver with regard to the driving control and adjust the personal space, and thus it is possible to perform the driving control of the vehicle M so that a discomfort of the occupant is small.

### Second Embodiment

Next, a second embodiment of the vehicle control device will be described. The second embodiment is different from the first embodiment in that an external device (for example, a server or a terminal device) is caused to perform some or all of the functions of the personal space estimator 110 and the HMI controller 180 in the configuration of the automated driving controller 100. Hereinafter, a management system including the external device and a vehicle including the automated driving controller 100 according to the second embodiment will be described.

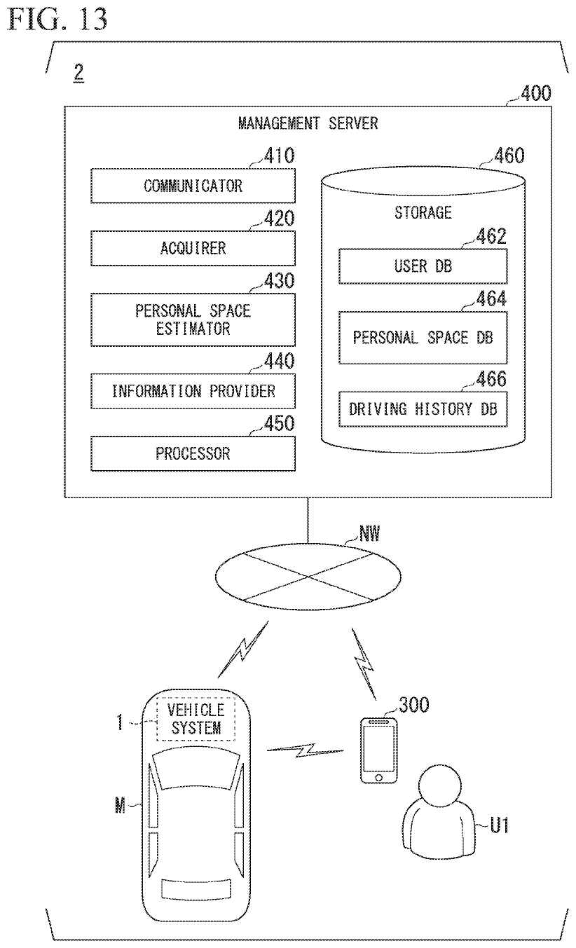

FIG. 13 is a diagram illustrating an example of a system configuration of a management system 2 including the vehicle control device according to the second embodiment. The management system 2 illustrated in FIG. 13 includes, for example, the vehicle M, a terminal device 300, and a management server 400. These constituent elements can communicate with each other via network NW. The network NW includes the Internet, a WAN, a LAN, a telephone line, a public line, a dedicated line, a provider device, and a wireless base station. The vehicle M and the terminal device 300 may directly perform communication through short-range wireless communication such as Bluetooth (registered trademark) through being involved in the network NW. A user U1 is a driver (an occupant) who drives the vehicle M and an owner of the terminal device 300. Hereinafter, the driver of the vehicle M is referred to as the user U1 in description. The vehicle system 1 including the automated driving controller 100 is mounted in the vehicle M. The terminal device 300 is, for example, a mobile terminal such as a smartphone or a tablet terminal. In the management system 2, the plurality of vehicles M and the plurality of terminal devices 300 may be provided.

The management server 400 includes, for example, a communicator 410, an acquirer 420, a personal space estimator 430, an information provider 440, a processor 450, and a storage 460. The acquirer 420, the personal space estimator 430, the information provider 440, and the processor 450 are implemented, for example, by causing a hardware processor such as a CPU to execute a program (software). Some or all of the constituent elements may be implemented by hardware (a circuit unit including circuitry) such as an LSI, an ASIC, an FPGA, or a GPU or may be implemented by software and hardware in cooperation. The program may be stored in advance in a storage device (a storage device including a non-transitory storage medium) such as an HDD or a flash memory or may be stored in a detachably mounted storage medium (a non-transitory storage medium) such as a DVD or a CD-ROM so that the storage medium is mounted on a drive device or the like to be installed on the storage device of the management server 400. For example, the management server 400 may communicate with the vehicle M or the terminal device 300 via the network NW and function as a cloud server that transmits and receives various kinds of data.

The storage 460 may be implanted by any of the foregoing storage devices, an EEPROM, a ROM, a RAM, and the like. The storage 460 stores, for example, a user database (DB) 462, a personal space DB 464, a driving history DB 466, a program, and other various kinds of information. The user DB 462 associates feature information such as a sex or an age, vehicle information for identifying a vehicle, and terminal information for identifying a terminal device with an occupant ID for identifying a driver who drives the vehicle M. Accordingly, the vehicle M used by an occupant (a user U1) with the occupant ID can be associated with the terminal device 300 with reference to the user DB 462. The personal space DB 464 stores a personal space associated with a feature of an occupant. The personal space DB 464 may store an individual personal space associated with the occupant ID. The driving history DB 466 stores a driving history of each occupant ID acquired from one or more vehicles.

The communicator 410 communicates with the vehicle M, the terminal device 300, any other external device via the network NW.

The acquirer 420 acquires various kinds of information from the vehicle M, the terminal device 300, and other devices connected to the network NW. For example, the acquirer 420 acquires the feature information of the user U1 or information regarding the response information (a questionnaire result) to the questionnaires from the terminal device 300. The acquirer 420 acquires information regarding the driving history of the occupant from the vehicle M. The acquirer 420 stores the feature information or the response information associated with the occupant ID acquired from the vehicle M or the terminal device 300 in the user DB 462 and stores the driving history associated with the occupant ID in the driving history DB 466. The acquirer 420 may perform a process of acquiring registration information of the user U1 from the vehicle M or the terminal device 300 and registering the information and may register the result in the user DB 462.

The personal space estimator 430 estimates a personal space using a position of the vehicle M as a reference based on the feature of the occupant instead of the personal space estimator 110 of the first embodiment. For example, the personal space estimator 430 generates information for inputting the feature information of the occupant or the questionnaire information regarding the driving control of the vehicle M when the occupant gets in the vehicle M, and transmits the generated information to the terminal device 300 of the user U1. Based on the feature information acquired from the terminal device 300, the personal space is estimated using the position of the vehicle M as the reference. The personal space estimator 430 updates the personal space based on one or both of the driving history acquired from the vehicle M and the response information (the questionnaire result) acquired from the terminal device 300.

The information provider 440 transmits personal space information in accordance with the feature of the user U1 to the vehicle M driven by the user U1. The information provider 440 may transmit, to the vehicle M, the personal space information in accordance with the feature of the user U1 in the personal space information of each feature of the occupant acquired through statistics processing or the like by the processor 450.

Here, the personal space estimator 110 according to the second embodiment transmits information regarding the feature of the occupant to the management server 400 and acquires the personal space based on the feature of the occupant from the management server 400. The personal space estimator 110 performs the driving control using the acquired personal space or stores the personal space in the storage 190 to manage the personal space. The personal space estimator 110 according to the second embodiment may change the personal space in real time based on the content of the driving control of the vehicle M or the state of the occupant. The HMI controller 180 according to the second embodiment transmits at least the feature information of the occupant and the driving history 196 stored in the storage 190 to the management server 400 at a predetermined timing.

The processor 450 performs, for example, a known analysis process, machine learning process, or statistics processing based on response information or driving histories of a plurality of occupants to estimate the personal space in accordance with each sex or age of an occupant or each model of the vehicle M, other features or a combination of the other features. The information may be stored in the personal space DB 464 or may be provided to the vehicle M, the terminal device 300, or other external devices via the network NW.

As described above, according to the second embodiment, the personal space can be learned statistically from a lot of information by the management server 400. By using the personal space provided from the management server 400, it is possible to perform driving control in accordance with the feature of the occupant. According to the second embodiment, although the user U1 drives a plurality of different vehicles, a personal space of the user U1 can be provided from the management server 400 to each vehicle. Accordingly, the user U1 can perform the driving control at an appropriate timing using the own personal space although the user U1 drives any vehicle.

### Processing Sequence

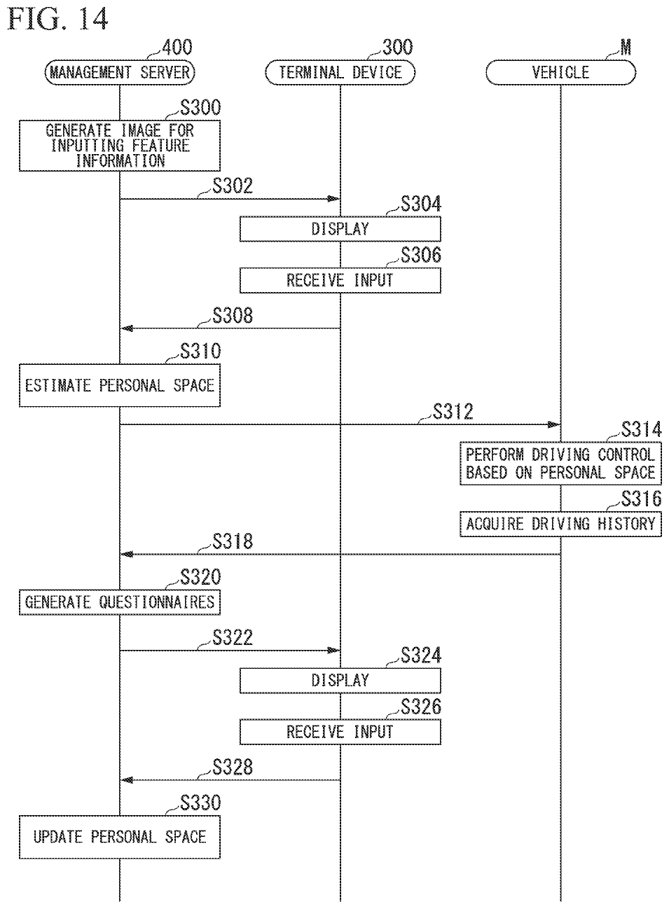

FIG. 14 is a sequence diagram illustrating an example of a flow of a process performed by the management system 2 according to the second embodiment. In FIG. 14, a flow of a process in which the management server 400, the terminal device 300, and the vehicle M are used is illustrated. In the example of FIG. 14, the management server 400 generates an image (for example, the image IM10) for inputting the feature information of the user U1 (step S300). The process of step S300 may be performed, for example, when the management server 400 receives a request for registering the feature information from the terminal device 300 or the vehicle M. Subsequently, the management server 400 transmits the generated image to the terminal device 300 (step S302). The terminal device 300 displays the image (for example, the image IM10) for inputting the feature information received from the management server 400 on a display included in the terminal device 300 to display (step S304).

For example, when the input of the feature information of the user U1 is received from the display that has a function of a touch panel (step S306), the terminal device 300 transmits the received feature information to the management server 400 (step S308). The management server 400 estimates the personal space based on the received feature information (step S310). Subsequently, the management server 400 transmits the estimated personal space information to the vehicle M driven by the user U1 (step S312).

The vehicle M performs the driving control based on the personal space transmitted from the management server 400 (step S314). Subsequently, the vehicle M acquires the driving history of the user U1 at the predetermined timing (step S316) and transmits the acquired driving history to the management server 400 (step S318).

The management server 400 generates an image (for example, the image IM30) indicating the questionnaire information related to the driving control (step S320) and transmits the generated questionnaire information to the terminal device 300 (step S322). The terminal device 300 displays the questionnaire information (for example, the image IM30) on the display (step S324), receives an input (the questionnaire result) of the user U1 (step S326), and transmits the received questionnaire result to the management server 400 (step S328). The management server 400 updates the personal space of the user U1 based on one or both of the driving history and the questionnaire result (step S330). The updated personal space may be transmitted to the vehicle M or may be stored in the personal space DB 464 of the storage 460. In addition to the process illustrated in FIG. 14, the management server 400 may generate the above-described image IM20, transmit the image IM20 to the terminal device 300, allow an occupant to set a personal space, and acquire the set information, and adjust the personal space.

According to the above-described second embodiment, it is possible to obtain advantages similar to those of the first embodiment and manage the personal spaces uniformly in the management server 400, and estimate a personal space based on a feature of an occupant using more information (a driving history and a questionnaire result) or the like. According to the first embodiment, it is possible to apply personal space information of each feature estimated by statistics processing or the like using a lot of data to research and development of a next-generation vehicle and implement automated driving control closer to a sensation of an occupant who actually performs driving.

The above-described embodiments can be expressed as follows.

A vehicle control device including:

a storage device that stores a program; and

a hardware processor,

wherein the hardware processor executes the program stored in the storage device to perform

estimating a personal space in which a position of a vehicle is a reference based on a feature of an occupant of the vehicle;

recognizing a surrounding situation of the vehicle including the estimated personal space; and

controlling one or both of steering and an acceleration or deceleration speed of the vehicle based on a situation in the recognized personal space.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
an estimator configured to estimate a personal space in which a position of a vehicle is a reference based on a feature of an occupant of the vehicle;
a recognizer configured to recognize a surrounding situation of the vehicle including the personal space estimated by the estimator; and
a driving controller configured to control one or both of steering and an acceleration or deceleration speed of the vehicle based on a situation in the personal space recognized by the recognizer.

2. The vehicle control device according to claim 1, further comprising:
an output controller configured to cause an outputter to output information for inputting information regarding the feature of the occupant,
wherein the estimator estimates the personal space of the occupant based on information input by the occupant in response to the information output to the outputter.

3. The vehicle control device according to claim 1, wherein the estimator updates the personal space based on a manual driving history of the vehicle by the occupant.

4. The vehicle control device according to claim 2, wherein, after the driving controller performs driving control based on a situation in the personal space, the output controller causes the outputter to output inquiry information about the driving control and the estimator updates the personal space based on response information to the inquiry information output by the outputter.

5. The vehicle control device according to claim 1, further comprising:
an occupant state detector configured to detect a state of the occupant,
wherein the estimator updates the personal space based on a visual line direction of the occupant detected by the occupant state detector.

6. The vehicle control device according to claim 2, wherein the output controller outputs information including at least the feature of the occupant and information regarding the personal space estimated based on the feature to an external device.

7. The vehicle control device according to claim 1, wherein the estimator transmits information regarding a feature of the occupant to an external device and acquires a personal space which is based on the feature of the occupant from the external device.

8. A vehicle control method causing a computer of a vehicle control device to perform:
estimating a personal space in which a position of a vehicle is a reference based on a feature of an occupant of the vehicle;
recognizing a surrounding situation of the vehicle including the estimated personal space; and
controlling one or both of steering and an acceleration or deceleration speed of the vehicle based on a situation in the recognized personal space.

9. A computer-readable non-transitory storage medium that stores a program causing a computer of a vehicle control device to perform:
estimating a personal space in which a position of a vehicle is a reference based on a feature of an occupant of the vehicle;
recognizing a surrounding situation of the vehicle including the estimated personal space; and
controlling one or both of steering and an acceleration or deceleration speed of the vehicle based on a situation in the recognized personal space.
